(19) United States
(12) Patent Application Publication
(10) Pub. No.: US 2008/0027798 A1
(43) Pub. Date: Jan. 31, 2008

(54) Serving advertisements based on keywords related to a webpage determined using external metadata

(76) Inventors: Shivkumar Ramamurthi, San Francisco, CA (US); Farzin Maghoul, Hayward, CA (US); Jan Pedersen, Los Altos Hills, CA (US); Ofer Mendelevitch, Redwood City, CA (US)

Correspondence Address: Stattler-Suh PC, 60 SOUTH MARKET, SUITE 480, SAN JOSE, CA, 95113, US

(21) Appl. No.: 11/492,387

(22) Filed: Jul. 25, 2006

(51) Int. Cl. G06Q 30/00

(52) U.S. Cl. 705/14

(57) ABSTRACT

Methods and apparatus for selecting advertisements to display to a user requesting a primary webpage is provided. Keywords related to the primary webpage are determined using internal information of the primary webpage and/or external information provided in neighboring webpages. The external information may include anchor text metadata of hyperlinks on neighboring webpages that link to the primary webpage or include the number of such hyperlinks having a same particular anchor text. Other internal and/or external information may be used to determine a list of keywords related to the primary webpage. One or more of keywords on the list are selected to represent the primary webpage according to one or more objectives. One or more advertisements are selected to be served to the user using the selected keywords. Machine learning techniques may be used to develop a model that automatedly determines keywords representing a webpage.

### FIELD OF THE INVENTION

The present invention is directed towards serving advertisements using keywords related to a webpage as determined by external metadata.

### BACKGROUND OF THE INVENTION

When a user makes a request for base content to a server via a network, additional content is also typically sent to the user along with the base content. The user can be a human user interacting with a user interface of a computer that transmits the request for base content. The user could also be another computer process or system that generates and transmits the request for base content programmatically.

Base content might include a variety of content and is typically provided and presented to a user as a published webpage. For example, base content presented as a webpage may include published information, such as articles about politics, business, sports, movies, weather, finance, health, consumer goods, etc. Additional content might include content that is relevant/related to the base content. For example, relevant additional content may include advertisements for products or services that are related to the base content.

Base content providers receive revenue from advertisers who wish to have their advertisements displayed to users and typically pay a particular amount each time a user clicks on one of their advertisements. Base content providers employ a variety of methods to determine which additional content to display to a user. The need for determining relevant advertisements is important in improving the user experience of a webpage and in maximizing advertiser revenue. Typically, the text content of a webpage is used to determine which advertisements to display to the user along with the requested webpage. Often, however, the text content of a webpage may not provide enough information to determine which advertisements are relevant to the webpage, or may provide inappropriate advertisements that are not relevant to the webpage. As such, there is a need for an improved method for determining advertisements relevant to a particular webpage.

### SUMMARY OF THE INVENTION

A method and apparatus for selecting advertisements to display to a user when the user requests a particular webpage (primary webpage) is provided. In some embodiments, the advertisements are selected by determining keywords (indicating topics/subject areas) related to the primary webpage. The keywords may be determined using internal information (i.e., information provided in the primary webpage) and/or external information (i.e., information provided in external neighboring webpages). In some embodiments, the external information includes anchor text metadata of hyperlinks presented on neighboring webpages that link to the primary webpage. In other embodiments, the external information includes the number of such hyperlinks having a same particular anchor text. In further embodiments, other internal and/or external information is used to determine keywords related to the primary webpage.

Using the internal and/or external information, a list of one or more keywords related to a primary webpage and a score for each keyword is determined. One or more of keywords on the list are then selected to produce a set of primary webpage keywords that represent the primary webpage. Keywords on the list may be selected as primary webpage keywords based on its score and/or one or more objectives. One or more advertisements are then selected to be served to the user based on the set of primary webpage keywords. For example, advertisements having an associated keyword matching one or more primary webpage keywords may be selected for serving. In some embodiments, machine learning (ML) techniques used to develop a ML model that automatedly determines keywords representing a webpage.

By considering information other than or in addition to the text content of the primary webpage, the accuracy of determining which topics/keywords are related to the primary webpage can be improved, especially when the text content of the primary webpage is not sufficient. Thus, when used in Internet advertising, the relevancy of advertisements served with the primary webpage can be increased to improve the user experience of the webpage and maximize advertiser revenue.

### BRIEF DESCRIPTION OF THE DRAWINGS

The novel features of the invention are set forth in the appended claims. However, for purpose of explanation, several embodiments of the invention are set forth in the following figures.

FIG. 1 shows a network environment in which some embodiments operate.

FIG. 2 shows a conceptual diagram of a revenue-optimization system.

FIG. 3 shows a conceptual diagram of the relationships between a primary webpage and neighboring webpages.

FIG. 4 shows a conceptual diagram of the operation of the keyword module.

FIG. 5 shows an example of a list of keywords and scores generated by the keyword module.

FIG. 6 is a flowchart of a method for selecting one or more advertisements to serve with a requested webpage based on keywords related to the requested webpage.

FIG. 7 shows a conceptual diagram of a machine learning system used to develop a machine learning (ML) model for use as the keyword module.

FIG. 8 is a flowchart of a method for developing a ML model for automatedly determining keywords representing a webpage.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

As described below, Section I discusses general terms and a network environment in which some embodiments operate. Section II discusses methods and apparatus for determining keywords representing a webpage to select advertisements to serve with the webpage. Section III discusses a machine-learning system used to develop a module for automatedly determining keywords representing a webpage.

### Section I: General Terms and Network Environment

As used herein, base content is requested by a user that may include a variety of content (e.g., news articles, emails, chat-rooms, etc.) having a variety of forms including text, images, video, audio, animation, program code, data structures, hyperlinks, etc. The base content is typically presented as a webpage and may be formatted according to the Hypertext Markup Language (HTML), the Extensible Markup Language (XML), Standard Generalized Markup Language (SGML), or any other language. As used herein, a primary webpage is requested by the user. Methods and apparatus described herein are used to determine keywords (indicating topics/subject areas) that represent the primary webpage to determine which advertisements to serve to the user requesting the primary webpage.

As used herein, additional content comprises one or more advertisements that are sent to the user that requests the primary webpage (base content) and are relevant to the primary webpage. An advertisement may comprise or include a hyperlink (e.g., sponsor link, integrated link, inside link, or the like). An advertisement may include a similar variety of content and form as the base content described above. The one or more advertisements are sent to the user along with the requested webpage or is sent at a later time (e.g., with the next webpage requested by the user).

As used herein, a base content provider is a network service provider (e.g., Yahoo! News, Yahoo! Music, Yahoo! Finance, Yahoo! Movies, Yahoo! Sports, etc.) that operates one or more servers that contain base content and receives requests for and transmits base content. A base content provider also sends additional content to users and employs methods for determining which additional content to send along with the requested base content, the methods typically being implemented by the one or more servers it operates.

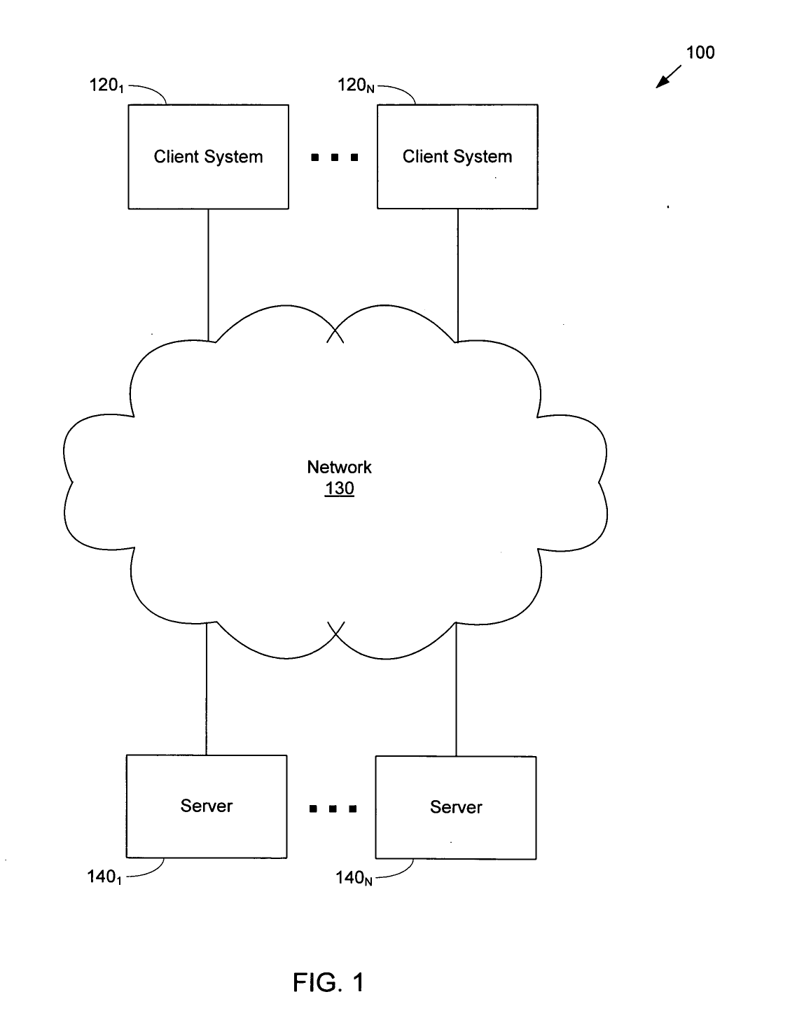

FIG. 1 shows a network environment 100 in which some embodiments operate. The network environment 100 includes client systems 120₁ to 120_{N} coupled to a network 130 (such as the Internet or an intranet, an extranet, a virtual private network, a non-TCP/IP based network, any LAN or WAN, or the like) and server systems 140₁ to 140_{N}. A server system may include a single server computer or a plurality of server computers. Each client system 120 is configured to communicate with any of server systems 140₁ to 140_{N}, for example, to request and receive base content and additional content.

The client system 120 may include a desktop personal computer, workstation, laptop, PDA, cell phone, any wireless application protocol (WAP) enabled device, or any other device capable of communicating directly or indirectly to a network. The client system 120 typically runs a web browsing program (such as Microsoft's Internet Explorer™ browser, Netscape's Navigator™ browser, Mozilla™ browser, Opera™ browser, a WAP-enabled browser in the case of a cell phone, PDA or other wireless device, or the like) allowing a user of the client system 120 to request and receive content from server systems 140₁ to 140_{N} over network 130. The client system 120 typically includes one or more user interface devices (such as a keyboard, a mouse, a roller ball, a touch screen, a pen or the like) for interacting with a graphical user interface (GUI) of the web browser on a display (e.g., monitor screen, LCD display, etc.).

In some embodiments, the client system 120 and/or system servers 140₁ to 140_{N} are configured to perform the methods described herein. The methods of some embodiments may be implemented in software or hardware configured to optimize the selection of additional content to be displayed to a user.

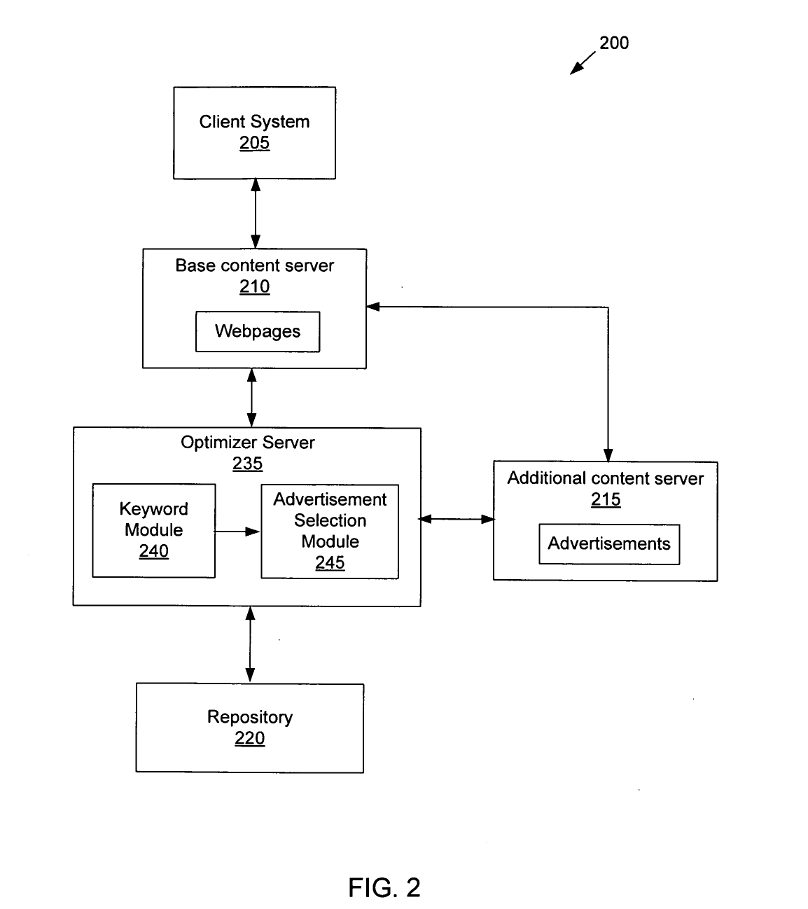

FIG. 2 shows a conceptual diagram of a revenue-optimization system 200. The revenue-optimization system 200 includes a client system 205, a base content server 210, an additional content server 215, a database of webpage information (repository) 220, and an optimizer server 235. The revenue-optimization system 200 is configured to select additional content (advertisements) to be sent to a user that maximizes expected revenue generation for a base content provider and advertisers. Various portions of the revenue-optimization system 200 may reside in one or more servers (such as servers 140₁ to 140_{N}) and/or one or more client systems (such as client systems 120₁ to 120_{N}).

The base content server 210 stores a plurality of webpages (base content) and is configured to receive webpage requests, retrieve and send requested webpages to the client system 205, and retrieve and send advertisements from the additional content server 215 to the client system 205. The additional content server 215 stores a plurality of advertisements (additional content), each advertisement being represented by and being associated with one or more keywords. The client system 205 is configured to send a webpage request to the base content server 210, receive the webpage and one or more advertisements from the base content server 210, display the webpage and one or more advertisements to the user, and receive selections of advertisements from the user (e.g., through a user interface).

The optimizer server 235 comprises a keyword module 240 and an advertisement selection module 245. The keyword module 240 receives a primary webpage (the webpage requested by the user) from the base content server 210 and webpage information from the repository 220 to determine a list of one or more keywords (indicating topics/subject areas) related to the primary webpage. The keyword module 240 then selects one or more keywords from the list to produce a set of primary webpage keywords that represent the primary webpage. As used herein, the term “keyword list” indicates the list of all keywords determined to be related to the primary webpage, whereas the term “primary webpage keyword” indicates a keyword from the keyword list selected to represent the primary webpage. In some embodiments, the keyword module 240 selects primary webpage keywords based on one or more objectives (e.g., to represent the intent of the primary webpage, to select keywords correlated to the intent of the primary webpage, or to create diversity in the primary webpage keywords). The keyword module 240 and the repository 220 are discussed in detail in Section II.

The advertisement selection module 245 receives the set of primary webpage keywords from the keyword module 240 and selects one or more advertisements from the additional content server 215 to serve to the user based on the set of primary webpage keywords. For example, the advertisement selection module 245 may select for serving those advertisements in the additional content server 215 having an associated keyword that matches one or more of the primary webpage keywords. As used herein, a keyword can comprise a single word (e.g., “cars,” “television,” etc.) or a plurality of words (e.g., “car dealer,” “New York City,” etc.). For example, the set of primary webpage keywords may comprise “automobile,” “sports car,” “sports car accessories,” etc. A particular advertisement may be represented by the keywords “sports car,” “high performance automobile,” etc. Since the advertisement keyword “sports car” matches the primary webpage keyword “sports car” (i.e., “sports car” represents the advertisement as well as the primary webpage), this particular advertisements may be selected for serving to the user.

The one or more selected advertisements are then retrieved from the additional content server 215 and sent to the client system 205. In some embodiments, the base content server 210 sends one or more selected advertisements to the client system 205 (user) along with the primary webpage requested by the user. In other embodiments, the base content server 210 sends the one or more selected advertisements to the client system 205 after it sends the primary webpage (e.g., along with a webpage that is later requested by the user).

As discussed above, a primary webpage is a webpage requested by a user and is the webpage for which related keywords are determined. A neighboring webpage is a webpage that is external to the primary webpage (i.e., has a different uniform resource locator address than the primary webpage) and is hyperlinked in some way to the primary webpage. A neighboring webpage may have a direct link to the primary page (i.e., may contain a hyperlink to the primary webpage or the primary webpage may contain a hyperlink to the neighboring webpage). Or a neighboring webpage may have an indirect link to the primary page, whereby the neighboring webpage is linked to the primary page through one or more intermediary neighboring webpages. For example, an indirect neighboring page may contain a hyperlink to an intermediary neighboring webpage that itself contains a hyperlink to the primary webpage. A hyperlink contained in a direct neighboring webpage that links to the primary webpage is referred to as an “inlink” (i.e., the primary webpage is the landing page of the hyperlink). A hyperlink contained in the primary webpage that links to a particular direct neighboring webpage is referred to as an “outlink” (i.e., the particular direct neighboring webpage is the landing page of the hyperlink).

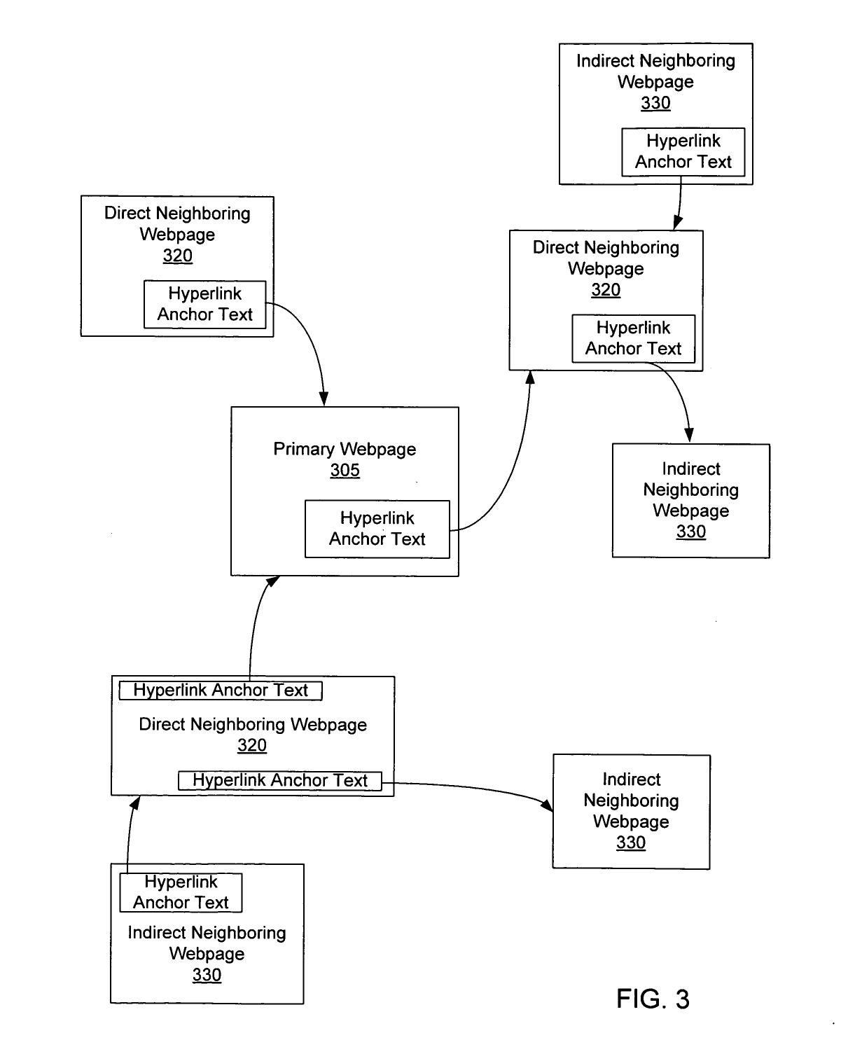

FIG. 3 shows a conceptual diagram of the relationships between a primary webpage 305, a plurality of direct neighboring webpages 320, and a plurality of indirect neighboring webpages 330. As shown in FIG. 3, the primary webpage 305 contains a hyperlink (outlink) that links to a direct neighboring webpage 320. FIG. 3 also shows a direct neighboring webpage 320 containing a hyperlink (inlink) that links to the primary webpage 305. FIG. 3 further shows a direct neighboring webpage 320 containing a hyperlink that links to an indirect neighboring webpage 330 and an indirect neighboring webpage 330 containing a hyperlink that links to a direct neighboring webpage 320.

Each webpage contains webpage information including content and one or more hyperlinks. Content comprises items such as text (e.g., news articles, movie reviews, etc.), graphics, images, animation, video, audio, etc. that are presented in the webpage. Information of the primary webpage is referred to herein as internal information, whereas information of a webpage external to the primary webpage (e.g., direct or indirect neighboring webpages) is referred to herein as external information.

As shown in FIG. 3, a webpage may contain a hyperlink having anchor text (metadata) comprising the visible text displayed for the hyperlink on the webpage. The anchor text of a hyperlink that links to a particular webpage typically provides some description of the particular webpage. For example, a hyperlink that links to a webpage listing current top pro golfers may contain the anchor text metadata “Top Pro Golfers.” In some embodiments, the anchor text for a hyperlink is classified as valid or invalid anchor text. In these embodiments, valid anchor text of a particular hyperlink provides useful information regarding the landing webpage of the particular hyperlink. Useful information may comprise, for example, new information that can not be determined from the text content of the landing webpage alone. In contrast, invalid anchor text of a particular hyperlink does not provide useful information regarding the landing webpage of the particular hyperlink. Non-useful information may also comprise, for example, information that can be determined from the text content of the landing webpage. Examples of invalid anchor text are “Click here,” “Open in a new window,” and www.JohnDoeWebpage.com.

In some embodiments, the related keywords of the primary webpage are determined using internal information (e.g., internal content, internal anchor text metadata, etc.) from the primary webpage. In other embodiments, the related keywords of the primary webpage are determined, at least in part, using external information (e.g., external content, external anchor text metadata, etc.) from one or more direct or indirect neighboring webpages (as discussed below in Section II).

### Section II: Determining Keywords Related to a Webpage to Serve Advertisements

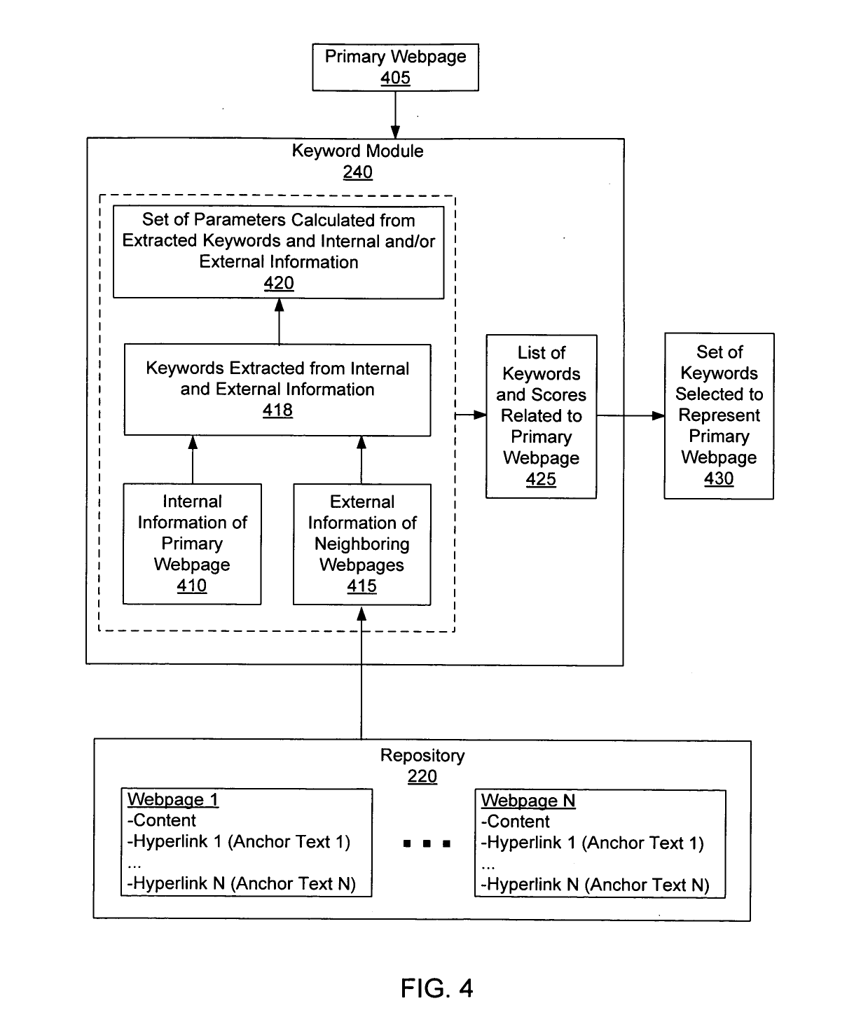

FIG. 4 shows a conceptual diagram of the operation of the keyword module 240 in determining keywords related to a webpage. As shown in FIG. 4, the keyword module 240 receives as input a primary webpage 405 and external webpage information from a repository 220 to produce an output of a set of primary webpage keywords 430 that are selected to represent the primary webpage 405. The keyword module 240 may be implemented in software or hardware configured to perform the functions described below.

The keyword module 240 may receive the primary webpage 405 by receiving the primary webpage 405 or by receiving the uniform resource locator (URL) address of the primary webpage 405 and then retrieving the primary webpage 405 from a network (such as the Internet). The keyword module 240 then extracts/collects particular information of the primary webpage 405 to produce internal information 410 of the primary webpage. In some embodiments, the internal information 410 comprises content (e.g., text, graphics, images, animation, video, audio, etc.) and one or more outlinks (containing anchor text metadata) of the primary webpage.

The keyword module 240 also receives and extracts/collects particular information of neighboring webpages from a repository 220 to produce external information 415. In some embodiments, the repository 220 comprises a database that stores and accumulates information on a plurality of webpages stored on a plurality of servers on a network (such as the Internet). In some embodiments, the repository 220 stores content and hyperlink information of the plurality of webpages. The webpage information may be accumulated using, for example, a web crawler that locates webpages stored on servers across the network and stores information of each found webpage. The repository 220 may be periodically updated to provide a current repository of website information. In some embodiments, the extracted external information 415 comprises content (e.g., text, graphics, images, animation, video, etc.) and hyperlinks (containing anchor text metadata) on direct or indirect neighboring webpages of the primary webpage. In some embodiments, the external information 415 comprises anchor text metadata of inlinks (presented on direct neighboring webpages) that link to the primary webpage 405.

The keyword module 240 then extracts/derives a set of keywords 418 from the internal and external information 410 and 415. For example, for the anchor text “Top Pro Golfers” the keyword module 240 may extract the keyword “Pro Golfers.” Each keyword in the set of extracted keywords 418 is unique from the other. Different methods for extracting keywords from webpage information may be used. Methods for extracting keywords from webpage information are well known in the art and not discussed in detail here.

The keyword module 240 then determines a set of parameters 420 for the internal and/or external information. In some embodiments, the keyword module 240 determines the set of parameters 420 using the extracted keywords 418 in combination with the internal and/or external information 410 and 415. The keyword module 240 then uses the extracted keywords 418 and the set of parameters 420 to determine a list 425 of one or more keywords (indicating topics/subject areas) related to the primary webpage and a numeric score for each keyword on the list. The score of a keyword indicates the strength of the relation/relevance of the keyword to the primary webpage. For instance, if the score ranges from 1 to 10, a score of 10 may be used to indicate that a keyword has a very strong relationship with the primary webpage and a score of 1 may be used to indicate that a keyword has a very weak relationship with the primary webpage. In some embodiments, a keyword having a relatively strong relationship with the primary webpage represents the intent of the primary webpage (i.e., what the primary webpage is about). In contrast, a keyword having a relatively weak relationship with the primary webpage represents a topic that is correlated with the intent of the primary webpage (as discussed below).

The keyword module 240 determines which extracted keywords 418 to include on the keyword list 425 and the score of each keyword on the list based on the set of parameters 420. In some embodiments, the set of parameters 420 for the internal and/or external information comprises, for each unique anchor text of an inlink to the primary webpage 405, the total number of inlinks to the primary webpage having the unique anchor text (i.e., the total number of times the unique anchor text appeared on all inlinks to the primary webpage). For instance, the total number of times the anchor text “Top Pro Golfers” appeared on all inlinks to the primary webpage may comprise a parameter in the set of parameters 420. As used herein, a number of instances of an item or event occurring on webpages over a network refers to the number of found or encountered instances of the item or event (e.g., as stored in the database repository) which typically does not equal the actual number of instances of the item or event occurring on all webpages over the network. For example, as used herein, the total number of inlinks to the primary webpage means the total number of found inlinks to the primary webpage.

In some embodiments, the set of parameters 420 for the internal and/or external information also includes a numeric weight determined for each extracted keyword, wherein a higher numeric weight produces a higher score for the extracted keyword on the keyword list 425. In some embodiments, the numeric weight of a keyword is affected (increases or decreases) based on other parameters in the set of parameters. For example, in some embodiments, the numeric weight of a keyword is based on the total number of times anchor text from which the keyword was extracted appeared on all inlinks to the primary webpage. In other embodiments, the numeric weight of a keyword is based on the total number of times anchor text from which the keyword was extracted appeared on hyperlinks to neighboring webpages. In further embodiments, the numeric weight of a keyword is based on whether the keyword matches or overlaps any keyword extracted from the text content of the primary webpage and/or the text content of a particular neighboring webpage.

As discussed below, the score of a keyword affects its probability of selection as a primary webpage keyword to represent the primary webpage, wherein a higher score typically increases the probability of selection. As such, the determination of a keyword to represent the primary webpage is based, at least in part, on external anchor text metadata of inlinks to the primary webpage and the number of instances of a particular anchor text metadata on all found inlinks to the primary webpage.

For example, if the keyword “Pro Golfers” was extracted from the anchor text “Top Pro Golfers,” the numeric weight of the keyword “Pro Golfers” may be based on the total number of times the anchor text “Top Pro Golfers” appeared on all inlinks to the primary webpage, wherein a higher total number produces a higher numeric weight, which in turn produces a higher keyword score and higher probability of selection of the keyword “Pro Golfers” as a primary webpage keyword. Note that the same unique keyword may be extracted from two different anchor text. For example, the keyword “Pro Golfers” may also be extracted from the anchor text “Pro USA Golfers” as well as the anchor text “Top Pro Golfers.” Where a keyword is extracted from two or more different anchor text, the numeric weight of the keyword may be based on the sum of the total number of times each different anchor text appeared on all inlinks to the primary webpage. For example, the numeric weight of the keyword “Pro Golfers” may be based on the sum of the total number of times the anchor text “Top Pro Golfers” and the total number of times the anchor text “Pro USA Golfers” appeared on all inlinks to the primary webpage.

In some embodiments, each parameter in the set of parameters for the internal and/or external information affects (i.e., increases or decreases) the numeric weight and score of one or more extracted keywords and the probability of selection of the one or more extracted keywords as a primary webpage keyword to represent the primary webpage. In some embodiments, the set of parameters for the internal and/or external information may comprise parameters relating to the primary webpage and may include zero or more of the following parameters:

number of inlinks to the primary webpage having a particular unique anchor text metadata;

number of inlinks to the primary webpage having valid anchor text metadata (i.e., anchor text that provides useful information regarding the primary webpage);

number of inlinks to the primary webpage having invalid anchor text metadata (i.e., anchor text that does not provide useful information regarding the primary webpage);

total number of inlinks to the primary webpage;

total number of unique keywords extracted from anchor text metadata on all inlinks to the primary webpage;

total number of keywords extracted from anchor text metadata on all outlinks to neighboring webpages;

number of keywords extracted from the text content of the primary webpage;

total number of indirect neighboring webpages that are linked to by direct neighboring webpages of the primary webpage;

size of the primary webpage as indicated, for example, by the number of words or bytes comprising the text content of the primary webpage;

presence or absence of a particular non-text content item (e.g., graphic, image, animation, video, audio, etc.) on the primary webpage;

quality level and/or size (e.g., resolution level, byte size, sampling rate, etc.) of a non-text content item on the primary webpage;

encoding language (e.g., English, French, Japanese, etc.) used for the text content of the primary webpage;

when (e.g., date and time) the primary webpage was created;

ratings or reviews of the primary webpage on neighboring webpages; and

folksonomy tags (tags from a user community that classify webpages to reflect the opinion of network users).

In some embodiments, the set of parameters may comprise parameters relating to a keyword extracted from anchor text metadata on an inlink to the primary webpage presented on a particular neighboring webpage and may include zero or more of the following parameters:

numeric weight computed for the keyword (where a higher numeric weight produces a higher score for the keyword);

total number of times the keyword is used in anchor text on all inlinks to the primary webpage;

number of words in the keyword;

whether the keyword appears more often by itself or as part of other keywords on other webpages of the Internet;

whether the keyword was extracted from valid or invalid anchor text metadata;

location of the particular neighboring webpage in relation to the primary webpage (e.g., whether the particular neighboring webpage is in the same domain or website as the primary webpage); and

whether the keyword matches or overlaps any keyword extracted from the text content of the primary webpage.

In some embodiments, the set of parameters may comprise parameters relating to a keyword extracted from anchor text metadata on a particular hyperlink (other than an inlink) presented on a particular neighboring webpage and may include zero or more of the following parameters:

numeric weight for the keyword (where a higher numeric weight produces a higher score for the keyword);

total number of times the keyword is used in anchor text on all links to the particular neighboring webpage;

location of the particular neighboring webpage in relation to the primary webpage (e.g., whether the neighboring webpage is in the same domain or website as the primary webpage);

whether the keyword was extracted from valid or invalid anchor text metadata; and

whether the keyword matches any keyword extracted from the text content of the neighboring webpage.

In some embodiments, the set of parameters may comprise parameters relating to a keyword extracted from text content of the primary webpage and may include zero or more of the following parameters:

numeric weight for the keyword (where a higher numeric weight produces a higher score for the keyword);

whether the keyword was extracted from text contained in the title or “meta” keyword section of the primary webpage;

size of the keyword (i.e., number of characters); and

number of times the keyword appears in the text content of the primary webpage.

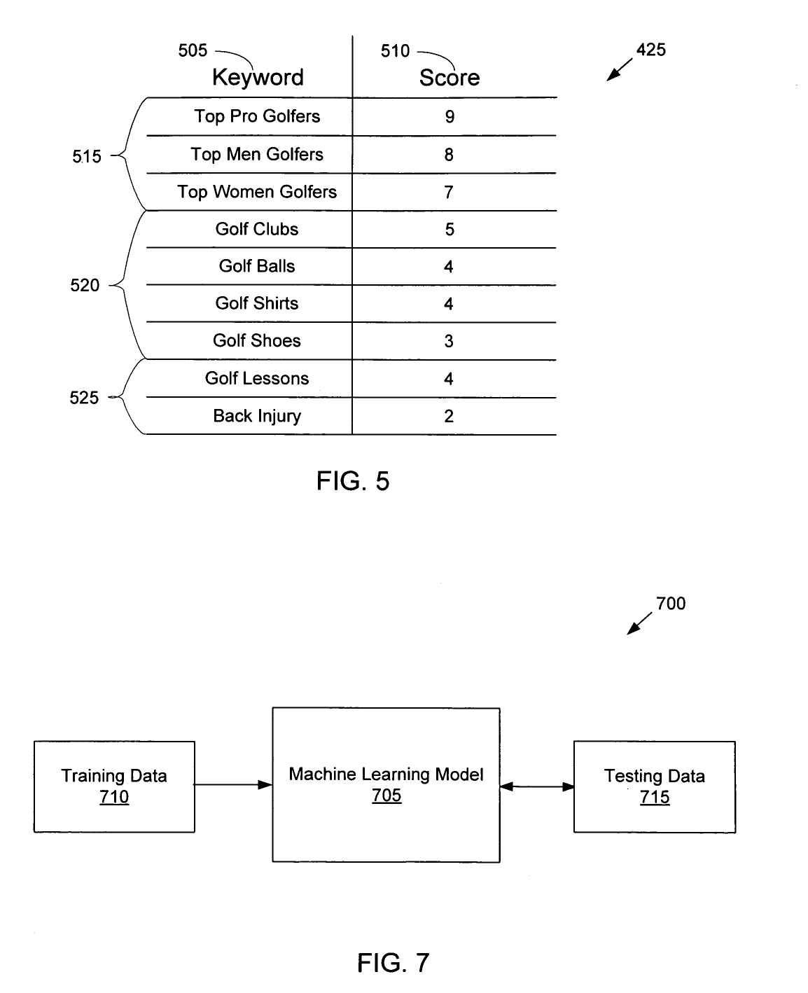

FIG. 5 shows an example of a list of keywords and scores 425 generated by the keyword module 420. In the example of FIG. 5, the list comprises a plurality of keywords 505 determined to be related to the primary webpage, each keyword having a score 510. In the example of FIG. 5, a score 510 comprises an integer number ranging from 1 (indicating the weakest relationship to the primary webpage) to 10 (indicating the strongest relationship to the primary webpage). In other embodiments, a score comprises a different type of number having a different range of values.

In some embodiments, the keyword module 240 divides/groups the keywords of the list 425 into groups of related keywords, each keyword in a group being related to a common theme/subject area. In the example shown in FIG. 5, the keywords 505 of the list have been divided into a first theme group of keywords 515 related to the subject area of “professional golfers,” a second theme group of keywords 520 related to the subject area of “golf gear and equipment,” and a third theme group of keywords 525 related to the subject area of “golf training and injuries.”

The keyword module 240 selects one or more keywords from the list of keywords 425 to produce a set of primary webpage keywords 430 selected to represent the primary webpage. The keyword module 240 may select primary webpage keywords 430 based on the keyword scores and/or the grouping of the keywords. In some embodiments, the keyword module 240 selects primary webpage keywords based on one or more objectives. In these embodiments, the primary webpage keywords may comprise intent keywords, correlated keywords, diversity keywords, or any combination of the three.

In some embodiments, one objective is to select primary webpage keywords (referred to as intent keywords) that represent the intent of the primary webpage. In some embodiments, the intent of a webpage comprises what the content of the webpage is essentially about or the primary/main subject matter(s) presented on the webpage. In other embodiments, the intent of a webpage also reflects an estimation as to the intent of the user in requesting the webpage (i.e., the user's intent that lead him/her to view this webpage). In some embodiments, keywords on the keyword list 425 having relatively high keyword scores may be selected as intent keywords. For example, the keyword module 240 may select the keywords from the list having the top three scores as intent keywords. In the example shown in FIG. 5, the top three scoring keywords “Top Pro Golfers,” “Top Men Golfers,” and “Top Women Golfers” may be selected as intent keywords.

In some embodiments, another objective is to select primary webpage keywords (referred to as correlated keywords) that are correlated with the intent of the primary webpage. Generally, a keyword that is correlated to a webpage does not represent the intent of the webpage, but indicates a topic/subject area that has a significant association/relationship (as is generally known in everyday usage) with the intent of the webpage. In some embodiments, keywords on the keyword list 425 having relatively low keyword scores may be selected as correlated keywords. For example, the keyword module 240 may select the keywords from the list having scores other than the top three scores as correlated keywords. In the example shown in FIG. 5, any of the keywords other than “Top Pro Golfers,” “Top Men Golfers,” and “Top Women Golfers” may be selected as correlated keywords.

Selection of correlated keywords to represent the primary webpage can be used to broaden the scope of related topics and the type of advertisements to be served with the primary webpage. For example, in FIG. 5, if correlated keywords “Golf Clubs” and “Golf Lessons” are selected to represent the primary webpage, advertisements relating to “Golf Clubs” and “Golf Lessons” may be served with the primary webpage instead of only advertisements related to the intent of the primary webpage. This in turn increases revenue for base content providers and advertisers.

In some embodiments, a further objective is to select primary webpage keywords (referred to as diversity keywords) that are diverse in themes/subject areas. As discussed above, in some embodiments, the keyword module 240 divides keywords of the list 425 into groups of related keywords having a common theme. In some embodiments, one or more keywords of two or more keyword theme groups are selected as diversity keywords. For example, the keyword module 240 may select the keyword having the highest score from each keyword theme group on the keyword list 425 as the diversity keywords. In the example shown in FIG. 5, the top scoring keyword “Top Pro Golfers” in the first theme group of keywords 515, the top scoring keyword “Golf Clubs” in the second theme group of keywords 520, and the top scoring keyword “Golf Lessons” in the third theme group of keywords 525 may be selected as the diversity keywords.

Selection of keywords diverse in themes/subject areas to represent the primary webpage can be used to produce diverse types of advertisements that are served with the primary webpage. For example, in FIG. 5, advertisements relating to “Top Pro Golfers,”

“Golf Clubs,” and “Golf Lessons” may be served with the primary webpage instead of only advertisements related to the intent of the primary webpage. This in turn increases revenue for base content providers and advertisers.

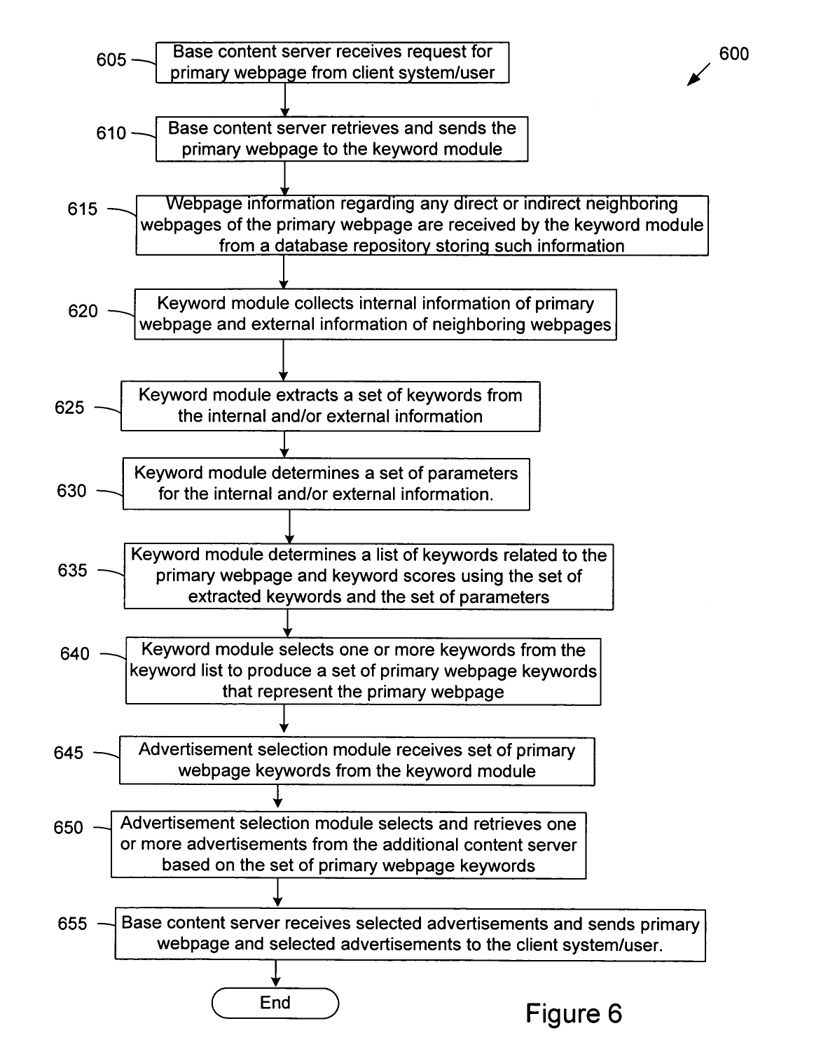

FIG. 6 is a flowchart of a method 600 for selecting one or more advertisements (additional content) to serve with a requested webpage based on keywords related to the requested webpage. In some embodiments, the method 600 is implemented by software or hardware configured to select the advertisements. In some embodiments, the steps of method 600 are performed using one or more servers (such as base content server 210, additional content server 215, and optimizer server 235), one or more modules (such as keyword module 240 or advertisement selection module 245), one or more databases (such as repository), and/or one or more client systems (such as client system 205). The order and number of steps of the method 600 are for illustrative purposes only and, in other embodiments, a different order and/or number of steps are used.

The method 600 begins when the base content server receives (at 605) a request for a webpage (primary webpage) from a client system/user. The base content server retrieves (at 610) the primary webpage and sends the primary webpage to the keyword module. Webpage information regarding any direct or indirect neighboring webpages of the primary webpage are also received (at 615) by the keyword module from a database repository storing such information.

The keyword module then collects (at 620) particular information of the primary webpage to produce internal information and particular information of the neighboring webpages to produce external information. In some embodiments, the internal information comprises content and one or more outlinks (containing anchor text metadata) of the primary webpage. In some embodiments, the external information comprises content and hyperlinks (containing anchor text metadata) on neighboring webpages.

The keyword module then extracts (at 625) a set of keywords from the internal and/or external information. The keyword module then determines (at 630) a set of parameters for the internal and/or external information. In some embodiments, the keyword module determines the set of parameters using the extracted keywords in combination with the internal and/or external information. In some embodiments, the set of parameters includes a numeric weight determined for each extracted keyword. In some embodiments, the numeric weight of a keyword is based on the total number of times anchor text from which the keyword was extracted appeared on all inlinks to the primary webpage.

In other embodiments, the set of parameters may comprise zero or more parameters relating to the primary webpage (total number of inlinks, number of keywords extracted from the text content, etc.), zero or more parameters relating to a keyword extracted from anchor text on an inlink (e.g., numeric weight, number of words, etc.), zero or more parameters relating to a keyword extracted from anchor text metadata on links (other than inlinks) contained in neighboring webpages (e.g., numeric weight, relative location of the neighboring webpage containing the link, etc.), and/or zero or more parameters relating to a keyword extracted from text content of the primary webpage (e.g., numeric weight, size of the keyword, etc.).

The keyword module then determines (at 635) a list of one or more keywords related to the primary webpage and a numeric score for each keyword on the list using the set of extracted keywords and determined the set of parameters. The score of a keyword indicates the strength of the relation/relevance of the keyword to the primary webpage. In some embodiments, the keywords list is divided into groups of related keywords, each keyword in a group being related to a common theme.

The keyword module 240 then selects (640) one or more keywords from the list of keywords to produce a set of primary webpage keywords that represent the primary webpage. The keyword module 240 may select primary webpage keywords based on the keyword scores and/or grouping of the keywords. In some embodiments, the keyword module selects primary webpage keywords based on one or more objectives (e.g., to select keywords that represent the intent of the primary webpage, to select keywords that are correlated with the intent of the primary webpage, and/or to select keywords that are diverse in themes/subject areas).

The advertisement selection module then receives (at 645) the set of primary webpage keywords from the keyword module. The advertisement selection module selects and retrieves (at 650) one or more advertisements from the additional content server 215 based on the set of primary webpage keywords (e.g., by selecting advertisements having matching associated keywords). The base content server receives (at 655) one or more selected advertisements and sends the primary webpage (requested webpage) and the selected advertisements to the client system/user. In some embodiments, the base content server sends the selected advertisements to the client system/user with the primary webpage, while in other embodiments, the selected advertisements are sent after the primary webpage (e.g., along with a later webpage requested by the client system/user). The method 600 then ends.

### Section III: Machine-Learning System to Develop a Keyword Module for Automatedly Determining Keywords Representing a Webpage

In some embodiments, the keyword module 240 of FIG. 2 is developed using machine learning techniques. FIG. 7 shows a conceptual diagram of a machine learning system 700 used to develop a machine learning (ML) model 705 for use as the keyword module 240. The machine learning system 700 comprises the ML model 705, training data 710, and testing data 715.

Training data 710 comprises a plurality of webpages, each webpage having content and zero or more hyperlinks. The training data 710 also includes, for each webpage, a set of parameters, a set of “correct” keywords, and a set “incorrect” keywords. The set of parameters are discussed above in detail in Section II and may comprise zero or more parameters relating to the webpage, zero or more parameters relating to a keyword extracted from anchor text on an inlink, zero or more parameters relating to a keyword extracted from anchor text metadata on links (other than inlinks) contained in neighboring webpages, and/or zero or more parameters relating to a keyword extracted from text content of the webpage. The set of parameters of a webpage included in the training data 710 comprise predetermined test parameters. The predetermined test parameters may be selected using any variety of methods. In some embodiments, an algorithm is used to select the predetermined test parameters (configured, for example, using machine learning techniques). In other embodiments, software developers/engineers select the predetermined test parameters. In further embodiments, another method is used to select the predetermined test parameters.

The set of “correct” keywords of a particular webpage comprise one or more keywords that are determined to properly/accurately represent the webpage (as predetermined, for example, by an algorithm, an algorithm configured using machine learning techniques, software developers/engineers, etc.) considering the particular webpage (content and hyperlinks) and the set of parameters for the particular webpage. In contrast, the set of “incorrect” keywords of a particular webpage comprise one or more keywords that are determined to improperly/inaccurately represent the webpage (as predetermined, for example, by an algorithm, an algorithm configured using machine learning techniques, software developers/engineers, etc.) considering the particular webpage (content and hyperlinks) and the set of parameters for the particular webpage. The “correct” or “incorrect” keywords for the particular webpage may be selected according to one or more objectives (e.g., to represent the intent of the particular webpage, to select keywords correlated to the intent of the particular webpage, or to select keywords diverse in themes).

Using the training data 710, the ML model 705 develops, through machine learning techniques, methods and algorithms to automatedly determine keywords to represent a new webpage (that the ML model 705 has not previously encountered/received) upon receiving the new webpage and a set of parameters for the new webpage. In some embodiments, the ML model 705 comprises the keyword module 240 or comprises a portion of the keyword module 240 in FIG. 2.

Note, however, that through machine learning techniques, the ML model 705 may develop methods and algorithms that differ from those of the keyword module 240 (as discussed above) to determine keywords that represent a webpage. For example, the ML model 705 may develop “short-cut” methods and algorithms represented as a mathematical function. As discussed above, each parameter in the set of parameters for the internal and/or external information affects (i.e., increases or decreases) the numeric weight and score of one or more extracted keywords and the probability of selection of the one or more extracted keywords as a primary webpage keyword. Using machine learning techniques, the ML model 705 considers each parameter in the set of parameters, its corresponding affect on the weight/score of a keyword, and its affect on producing “correct” primary webpage keywords. Machine learning techniques are well known in the art and not discussed in detail here.

In some embodiments, the ML model 705 is further refined and tested with testing data 715 comprising a plurality of webpages and, for each webpage, a set of parameters, a set of “correct” keywords, and a set “incorrect” keywords. The ML model 705 is further refined and tested with the testing data 715 until the ML model 705 produces accurate keywords (to a satisfactory degree) representing new webpages.

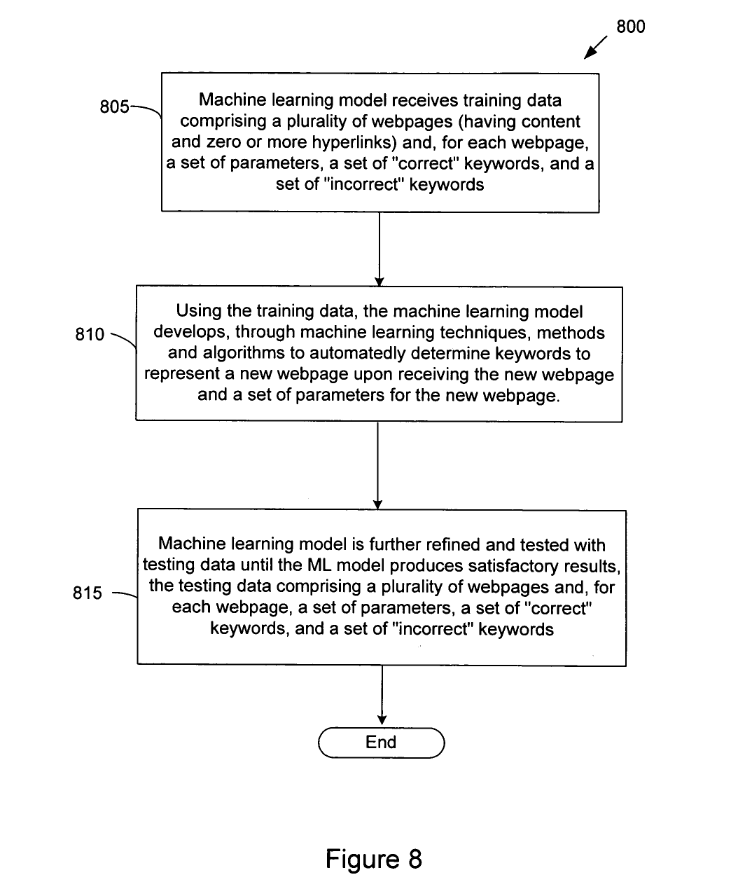

FIG. 8 is a flowchart of a method 800 for developing a ML model for automatedly determining keywords representing a webpage. The method 800 begins when the ML model receives (at 805) training data 710 comprising a plurality of webpages (having content and zero or more hyperlinks) and, for each webpage, a set of parameters, a set of “correct” keywords, and a set of “incorrect” keywords. Using the training data, the ML model develops (at 810), through machine learning techniques, methods and algorithms to automatedly determine keywords to represent a new webpage upon receiving the new webpage and a set of parameters for the new webpage. The ML model is further refined and tested (at 815) with testing data 715 until the ML model produces satisfactory results, the testing data 715 comprising a plurality of webpages and, for each webpage, a set of parameters, a set of “correct” keywords, and a set of “incorrect” keywords. The method 800 then ends.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A system for selecting one or more advertisements to serve to a user requesting a primary webpage, the primary webpage having one or more external neighboring webpages that hyperlink directly or indirectly to the primary webpage, the system comprising:
a keyword module configured for:
selecting a set of primary webpage keywords representing the primary webpage based, at least in part, on external information from one or more neighboring webpages; and
an advertisement selection module configured for:
selecting one or more advertisements to serve to the user based on the set of primary webpage keywords.

2. The system of claim 1, wherein the external information comprises anchor text of one or more hyperlinks to the primary webpage presented on one or more neighboring webpages.

3. The system of claim 2, wherein the keyword module is further configured for determining the set of primary webpage keywords based, at least in part, on a number of instances of a specific anchor text on hyperlinks to the primary webpage presented on the neighboring webpages.

4. The system of claim 1, wherein the keyword module is further configured for:
extracting a set of keywords from external information from one or more neighboring webpages;
determining a set of parameters for the external information; and
determining a list of keywords related to the primary webpage and a score for each keyword on the list using the set of extracted keywords and the set of parameters for the external information, wherein the set of primary webpage keywords are selected from the list of keywords.

5. The system of claim 4, wherein the keyword module is further configured for:
creating two or more groups of keywords in the list of keywords, each keyword in a group being related to a common subject area, wherein the set of primary webpage keywords are selected from the list of keywords based on the scores of the keywords or the grouping of the keywords,
wherein the keyword module is configured for selecting the set of primary webpage keywords from the list of keywords to represent the intent of the primary webpage, to select keywords that are correlated with the intent of the primary webpage, or to select keywords that are diverse in subject areas.

6. The system of claim 4, wherein the keyword module is further configured for:
extracting a set of keywords from internal information from the primary webpage; and
determining a set of parameters for the internal information, wherein the list of keywords and score for each keyword on the list are determined using the sets of extracted keywords from the internal and external information and the sets of parameters for the internal and external information.

7. The system of claim 6, wherein the set of parameters relates to the primary webpage and comprises one or more of the following parameters:
number of hyperlinks to the primary webpage having valid anchor text;
number of hyperlinks to the primary webpage having invalid anchor text;
number of hyperlinks to the primary webpage;
number of keywords extracted from anchor text on hyperlinks to the primary webpage or on hyperlinks to neighboring webpages;
number of keywords extracted from text content of the primary webpage;
number of neighboring webpages that are indirectly linked to by neighboring webpages directly linked to the primary webpage;
size of text content of the primary webpage;
quality level or size of a non-text content item on the primary webpage;
presence or absence of a graphic, image, animation, video, or audio on the primary webpage;
encoding language of the primary webpage;
when the primary webpage was created;
ratings or reviews of the primary webpage on neighboring webpages; or
folksonomy tags.

8. The system of claim 6, wherein the set of parameters relates to a keyword extracted from anchor text on a particular hyperlink to the primary webpage presented on a particular neighboring webpage and comprises one or more of the following parameters:
numeric weight for the keyword;
number of times the keyword is used on anchor text on hyperlinks to the primary webpage;
number of words in the keyword;
whether the keyword appears more often by itself or as part of other keywords on webpages of the Internet;
whether the keyword was extracted from valid or invalid anchor text;
whether the particular neighboring webpage is in the same domain or website as the primary webpage; or
whether the keyword matches any keyword extracted from the text content of the primary webpage.

9. The system of claim 6, wherein the set of parameters relates to a keyword extracted from anchor text on a particular hyperlink that is not a hyperlink to the primary webpage presented on a particular neighboring webpage and comprises one or more of the following parameters:
numeric weight for the keyword;
number of times the keyword is used in anchor text on links to the particular neighboring webpage;
whether the particular neighboring webpage is in the same domain or website as the primary webpage;
whether the keyword was extracted from valid or invalid anchor text; or
whether the keyword matches any keyword extracted from the text content of the neighboring webpage.

10. The system of claim 6, wherein the set of parameters relates to a keyword extracted from text content of the primary webpage and comprises one or more of the following parameters:
numeric weight for the keyword;
whether the keyword was extracted from text contained in the title or “meta” keyword section of the primary webpage;
size of the keyword; or
number of times the keyword appears in the text content of the primary webpage.

11. The system of claim 1 wherein the keyword module is developed using machine learning techniques to automatedly determine a set of primary webpage keywords representing the primary webpage upon receiving the primary webpage and the external information.

12. The system of claim 1, further comprising:
a client system used by the user, the client system configured for sending the request for the primary webpage and receiving the primary webpage and the one or more advertisements;
a webpage server connected to the client system via a network and to the keyword module, the webpage server configured for storing a plurality of webpages, receiving the request for the primary webpage, and sending the requested webpage and the one or more advertisements to the client system;
an advertisement server connected to the keyword module and the webpage server, the advertisement server configured for storing a plurality of advertisements and sending the one or more advertisements to the webpage server; and
a database connected to the keyword module, the database configured for storing webpage information for a plurality of webpages and sending webpage information to the keyword module.

13. A computer-implemented method for selecting one or more advertisements to serve to a client system requesting a primary webpage through a network, the primary webpage having one or more external neighboring webpages that hyperlink directly or indirectly to the primary webpage, the method comprising:
selecting a set of primary webpage keywords representing the primary webpage based, at least in part, on external information from one or more neighboring webpages;
selecting one or more advertisements to serve to the client system based on the set of primary webpage keywords; and
sending the primary webpage and the one or more advertisements to the client system through the network.

14. The method of claim 13, wherein the external information comprises anchor text of one or more hyperlinks to the primary webpage presented on one or more neighboring webpages.

15. The method of claim 14, wherein determining the set of primary webpage keywords comprises determining the set of primary webpage keywords based, at least in part, on a number of instances of a specific anchor text on hyperlinks to the primary webpage presented on the neighboring webpages.

16. The method of claim 13, further comprising:
extracting a set of keywords from external information from one or more neighboring webpages;
determining a set of parameters for the external information; and
determining a list of keywords related to the primary webpage and a score for each keyword on the list using the set of extracted keywords and the set of parameters for the external information, wherein the set of primary webpage keywords are selected from the list of keywords.

17. The method of claim 16, further comprising:
creating two or more groups of keywords in the list of keywords, each keyword in a group being related to a common subject area, wherein the set of primary webpage keywords are selected from the list of keywords based on the scores of the keywords or the grouping of the keywords,
wherein selecting the set of primary webpage keywords comprises selecting the set of primary webpage keywords from the list of keywords to represent the intent of the primary webpage, to select keywords that are correlated with the intent of the primary webpage, or to select keywords that are diverse in subject areas.

18. The method of claim 16, further comprising:
extracting a set of keywords from internal information from the primary webpage; and
determining a set of parameters for the internal information, wherein the list of keywords and score for each keyword on the list are determined using the sets of extracted keywords from the internal and external information and the sets of parameters for the internal and external information.

19. The method of claim 18, wherein the set of parameters relates to the primary webpage and comprises one or more of the following parameters:
number of hyperlinks to the primary webpage having valid anchor text;
number of hyperlinks to the primary webpage having invalid anchor text;
number of hyperlinks to the primary webpage;
number of keywords extracted from anchor text on hyperlinks to the primary webpage or on hyperlinks to neighboring webpages;
number of keywords extracted from text content of the primary webpage;
number of neighboring webpages that are indirectly linked to by neighboring webpages directly linked to the primary webpage;
size of text content of the primary webpage;
quality level or size of a non-text content item on the primary webpage;
presence or absence of a graphic, image, animation, video, or audio on the primary webpage;
encoding language of the primary webpage;
when the primary webpage was created;
ratings or reviews of the primary webpage on neighboring webpages; or
folksonomy tags.

20. The method of claim 18, wherein the set of parameters relates to a keyword extracted from anchor text on a particular hyperlink to the primary webpage presented on a particular neighboring webpage and comprises one or more of the following parameters:
numeric weight for the keyword;
number of times the keyword is used on anchor text on hyperlinks to the primary webpage;
number of words in the keyword;
whether the keyword appears more often by itself or as part of other keywords on webpages of the Internet;
whether the keyword was extracted from valid or invalid anchor text;
whether the particular neighboring webpage is in the same domain or website as the primary webpage; or
whether the keyword matches any keyword extracted from the text content of the primary webpage.

21. The method of claim 18, wherein the set of parameters relates to a keyword extracted from anchor text on a particular hyperlink that is not a hyperlink to the primary webpage presented on a particular neighboring webpage and comprises one or more of the following parameters:
numeric weight for the keyword;
number of times the keyword is used in anchor text on links to the particular neighboring webpage;
whether the particular neighboring webpage is in the same domain or website as the primary webpage;
whether the keyword was extracted from valid or invalid anchor text; or
whether the keyword matches any keyword extracted from the text content of the neighboring webpage.

22. The method of claim 18, wherein the set of parameters relates to a keyword extracted from text content of the primary webpage and comprises one or more of the following parameters:
numeric weight for the keyword;
whether the keyword was extracted from text contained in the title or “meta” keyword section of the primary webpage;
size of the keyword; or
number of times the keyword appears in the text content of the primary webpage.
